(19) United States
(12) Patent Application Publication
(10) Pub. No.: US 2012/0081994 A1
(43) Pub. Date: Apr. 5, 2012

(54) Seismic Streamer Connection Unit

(76) Inventors: Vidar Anders Husom, Asker (NO); Geir A. M. Drange, Asker (NO); Svein Arne Frivik, Oslo (NO); Rune Voldsbekk, Drammen (NO); Roger Ellingsen, Borgen (NO); Olav Oeiberg, Sandvika (NO); Jens Olav Paulsen, Reistad (NO)

(21) Appl. No.: 12/896,628

(22) Filed: Oct. 1, 2010

(51) Int. Cl. G01V 1/38

(52) U.S. Cl. 367/16

(57) ABSTRACT

An apparatus includes a streamer cable section and a unit. The streamer cable section includes an associated group of seismic sensors. The unit connects to an end of the streamer cable section and includes a steering device, a controller, a network repeater and a router. The steering device is controllable to position the streamer section; the controller gathers seismic data provided by the associated group of seismic sensors and introduces the seismic data to a telemetry network of a streamer; the network repeater repeats a signal communicated along the telemetry network; and the router is disposed between the controller and the telemetry network.

### BACKGROUND

The invention generally relates to a seismic streamer connection unit.

Seismic exploration involves surveying subterranean geological formations for hydrocarbon deposits. A survey typically involves deploying seismic source(s) and seismic sensors at predetermined locations. The sources generate seismic waves, which propagate into the geological formations creating pressure changes and vibrations along their way. Changes in elastic properties of the geological formation scatter the seismic waves, changing their direction of propagation and other properties. Part of the energy emitted by the sources reaches the seismic sensors. Some seismic sensors are sensitive to pressure changes (hydrophones), others to particle motion (e.g., geophones and/or accelerometers), and industrial surveys may deploy only one type of sensor or both. In response to the detected seismic events, the sensors generate electrical signals to produce seismic data. Analysis of the seismic data can then indicate the presence or absence of probable locations of hydrocarbon deposits.

Some surveys are known as “marine” surveys because they are conducted in marine environments. However, “marine” surveys may be conducted not only in saltwater environments, but also in fresh and brackish waters. In one type of marine survey, called a “towed-array” survey, an array of seismic sensor-containing streamers and sources is towed behind a survey vessel.

### SUMMARY

In an embodiment of the invention, an apparatus includes a streamer cable section and a unit. The streamer cable section includes an associated group of seismic sensors. The unit connects to an end of the streamer cable section and includes a steering device, a controller, a network repeater and a router. The steering device is controllable to position the streamer section; the controller gathers seismic data provided by the associated group of seismic sensors and introduces the seismic data to a telemetry network of a streamer; the network repeater repeats a signal communicated along the telemetry network; and the router is disposed between the controller and the telemetry network.

In another embodiment of the invention, a technique includes concatenating streamer sections together using connection units to form a seismic streamer. The method includes, in at least one of the connection units, disposing a steering device controllable to position the streamer, a controller to gather seismic data provided by a group of seismic sensors associated with one of the streamer sections and introduce the seismic data to a telemetry network of the streamer, a network repeater to repeat a signal communicated along the telemetry network and a router between the controller and the telemetry network.

Advantages and other features of the invention will become apparent from the following drawing, description and claims.

### BRIEF DESCRIPTION OF THE DRAWING

FIG. 1 a schematic diagram of a marine-based seismic acquisition system according to an embodiment of the invention.

FIG. 2 is a flow diagram depicting a technique to construct and use a seismic streamer according to an embodiment of the invention.

FIG. 3 is a perspective view of a seismic streamer connection unit according to an embodiment of the invention.

FIG. 4 is a schematic diagram illustrating circuitry of the connection unit of FIG. 3 according to an embodiment of the invention.

### DETAILED DESCRIPTION

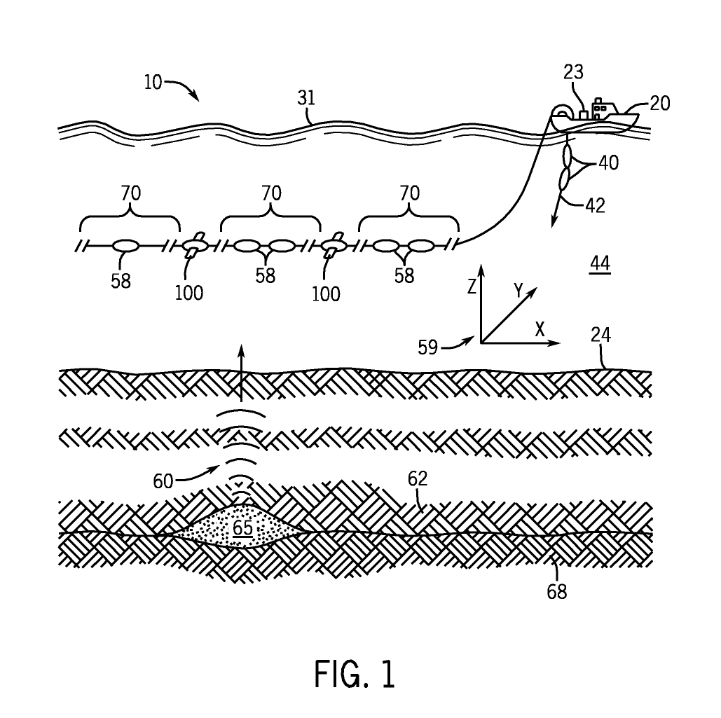

FIG. 1 depicts an embodiment 10 of a marine-based seismic data acquisition system in accordance with some embodiments of the invention. In the system 10, a survey vessel 20 tows one or more seismic streamers 30 (one exemplary streamer 30 being depicted in FIG. 1) behind the vessel 20. In one non-limiting example, the streamers 30 may be arranged in a spread in which multiple streamers 30 are towed in approximately the same plane at the same depth. As another non-limiting example, the streamers may be towed at multiple depths, such as in an over/under spread, for example.

Each seismic streamer 30 may be several thousand meters long and may contain various support cables (not shown), as well as wiring and/or circuitry (not shown) that may be used to support communication along the streamers 30. In general, the streamer 30 includes a primary cable into which is mounted seismic sensors that record seismic signals.

In accordance with embodiments of the invention, the streamer 30 is a multi-component streamer, which means that the streamer 30 contains particle motion sensors and pressure sensors 58. Each pressure sensor is capable of detecting a pressure wavefield, and each particle motion sensor is capable of detecting at least one component of a particle motion that is associated with acoustic signals that are proximate to the sensor. Examples of particle motions include one or more components of a particle displacement, one or more components (inline (x), crossline (y) and vertical (z) components (see axes 59, for example)) of a particle velocity and one or more components of a particle acceleration.

Depending on the particular embodiment of the invention, the streamer 30 may include hydrophones, geophones, particle displacement sensors, particle velocity sensors, accelerometers, pressure gradient sensors, or combinations thereof.

As a non-limiting example, in accordance with some embodiments of the invention, the particle motion sensor measures at least one component of particle motion along a particular sensitive axis 59 (the x, y or z axis, for example). As a more specific example, the particle motion sensor may measure particle velocity along the depth, or z, axis; particle velocity along the crossline, or y, axis; and/or velocity along the inline, or x, axis. Alternatively, in other embodiments of the invention, the particle motion sensor(s) may sense a particle motion other than velocity (an acceleration, for example).

In addition to the streamer(s) 30 and the survey vessel 20, the marine seismic data acquisition system 10 also includes one or more seismic sources 40 (two exemplary seismic sources 40 being depicted in FIG. 1), such as air guns and the like. In some embodiments of the invention, the seismic source(s) 40 may be coupled to, or towed by, the survey vessel 20. Alternatively, in other embodiments of the invention, the seismic source(s) 40 may operate independently of the survey vessel 20, in that the source(s) 40 may be coupled to other vessels or buoys, as just a few examples.

As the seismic streamers 30 are towed behind the survey vessel 20, acoustic signals 42 (an exemplary acoustic signal 42 being depicted in FIG. 1), often referred to as “shots,” are produced by the seismic source(s) 40 and are directed down through a water column 44 into strata 62 and 68 beneath a water bottom surface 24. The acoustic signals 42 are reflected from the various subterranean geological formations, such as an exemplary formation 65 that is depicted in FIG. 1.

The incident acoustic signals 42 that are created by the seismic source(s) 40 produce corresponding reflected acoustic signals, or pressure waves 60, which are sensed by the towed seismic sensors. It is noted that the pressure waves that are received and sensed by the seismic sensors include “up going” pressure waves that propagate to the sensors without reflection, as well as “down going” pressure waves that are produced by reflections of the pressure waves 60 from an air-water boundary, or free surface 31.

The seismic sensors generate signals (digital signals, for example), called “traces,” which indicate the acquired measurements of the pressure and particle motion wavefields. The traces are recorded and may be at least partially processed by a signal processing unit 23 that is deployed on the survey vessel 20, in accordance with some embodiments of the invention. For example, a particular pressure sensor may provide a trace, which corresponds to a measure of a pressure wavefield by its hydrophone; and a given particle motion sensor may provide (depending on the particular embodiment of the invention) one or more traces that correspond to one or more components of particle motion.

The goal of the seismic acquisition is to build up an image of a survey area for purposes of identifying subterranean geological formations, such as the exemplary geological formation 65. Subsequent analysis of the representation may reveal probable locations of hydrocarbon deposits in subterranean geological formations. Depending on the particular embodiment of the invention, portions of the analysis of the representation may be performed on the seismic survey vessel 20, such as by the signal processing unit 23. In accordance with other embodiments of the invention, the representation may be processed by a data processing system that may be, for example, located on land, on a streamer 30, distributed on several streamers 30, on a vessel other than the vessel 20, etc.

In accordance with embodiments of the invention described herein, the seismic streamer 30 is formed from a concatenation of seismic streamer sections 70. Each streamer section 70 has an associated group of the seismic sensors 58, which may be pressure sensors and/or particle motion sensors, depending on the particular embodiment of the invention. The streamer sections 70 are mechanically, electrically and possibly optically connected by streamer connection units 100. Thus, in general, each connection unit 100 connects the end of a particular streamer section 70 to the end of another streamer section 70.

Depending on the particular implementation, the connection unit 100 is a fully integrated seismic backbone and navigation device that performs one or more (if not all) of the following functions: ties in seismic sensor data into the telemetry system of the streamer 30; is steerable to control the position of the streamer 30 at the location of the unit 100; has sensors for determining the actual position, heading and inclination of the unit 100; and has at least one acoustic source for providing an acoustic positioning signal, thereby allowing seismic sensors 58 to ascertain the position of the sensors 58 and connection unit 100. Due to the integration of these components, which have conventionally been distributed along the streamer, into the connection unit 100, the streamer 30 may be spooled onto a storage reel without removing the components. Furthermore, the components may be integrated into the power system of the streamer 30 so that the components do not need to be separately charged.

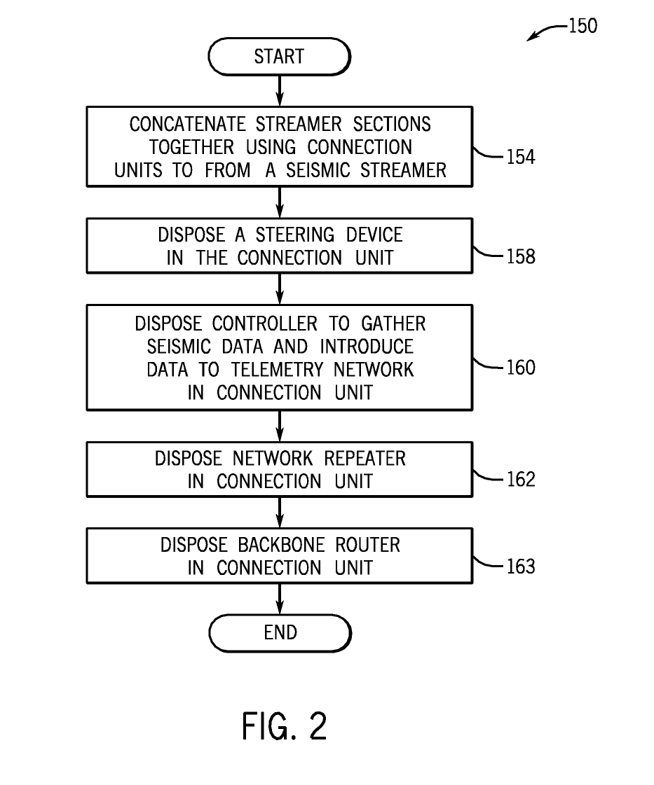

Referring to FIG. 2, to summarize, a technique 150 in accordance with some embodiments of the invention includes concatenating (block 154) streamer sections 70 together using connection units. The technique includes disposing various components in the connection units, such as a steering device (block 158), a controller to gather sensor data (block 160), a network repeater (block 162) and a backbone router (block 163).

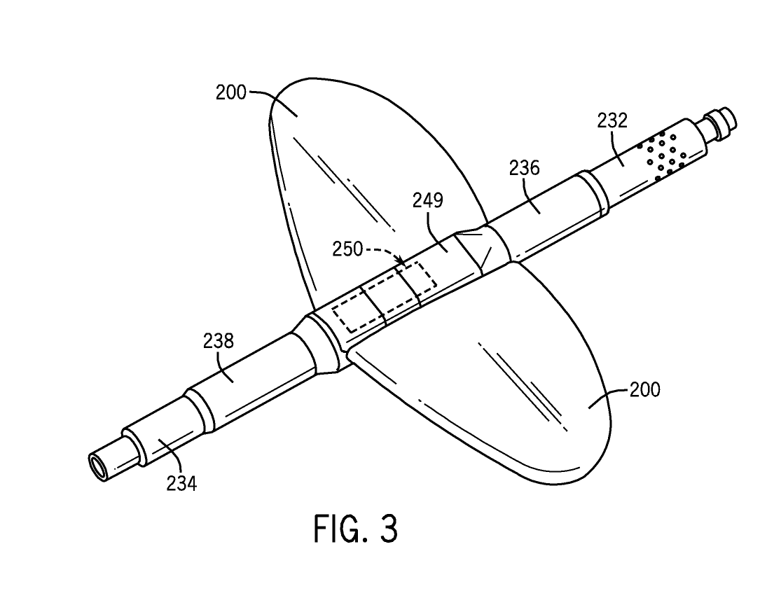

FIG. 3 depicts a general perspective view of the connection unit 100 in accordance with some embodiments of the invention. In general, a steerable “bird” is integrated into the connection unit 100, and as such, the connection unit 100 includes wings 200 that are controlled by circuitry 250 of the connection unit 100 for purposes of laterally and vertically positioning the unit 100 as the streamer 30 is being towed. In this regard, commands may be communicated to the circuitry 250 from a streamer-disposed controller or a vessel-disposed controller for purposes of changing the orientations of the wings 200 to finely and coarsely control the lateral and vertical positioning of the connection unit 100. In general, the circuitry 250 may be disposed inside a housing 249 of the connection unit 100, and, as shown in FIG. 3, the housing 249 may be disposed between end connectors 232 and 234 of the unit 100.

In this manner, the end connectors 232 and 234 form mechanical, electrical and possibly optical connections for the connection unit 100 and may be disposed on opposite ends of the connection unit 100 as shown in FIG. 3. The end connectors 232 and 234 are constructed to mate with complimentary mating connectors on the adjacent streamer sections 70 (see FIG. 1) that are joined by the connection unit 100. As a more specific example, in accordance with some embodiments of the invention, one connector 232 may be a female-type connector that mates with the corresponding male connector on one of the adjacent streamer sections 70; and the other connector 234 may be a male connector that mates with a corresponding female-type connector on the other adjacent streamer section 70. Other types of connectors may be used, in accordance with other embodiments of the invention.

As also shown in FIG. 3, in accordance with some embodiments of the invention, the connection unit 100 may further include resilient sections 236 and 238, which form corresponding flexible connections between the main relatively rigid portion of the connector unit 100 which houses the connection unit circuit 250 and from which the wings 200 extend. In this manner, the flexible section 236 is depicted in FIG. 3 as being disposed between the connector 232 and the main body, and the connector 238 is shown in FIG. 3 as being disposed between the connector 234 and the main body.

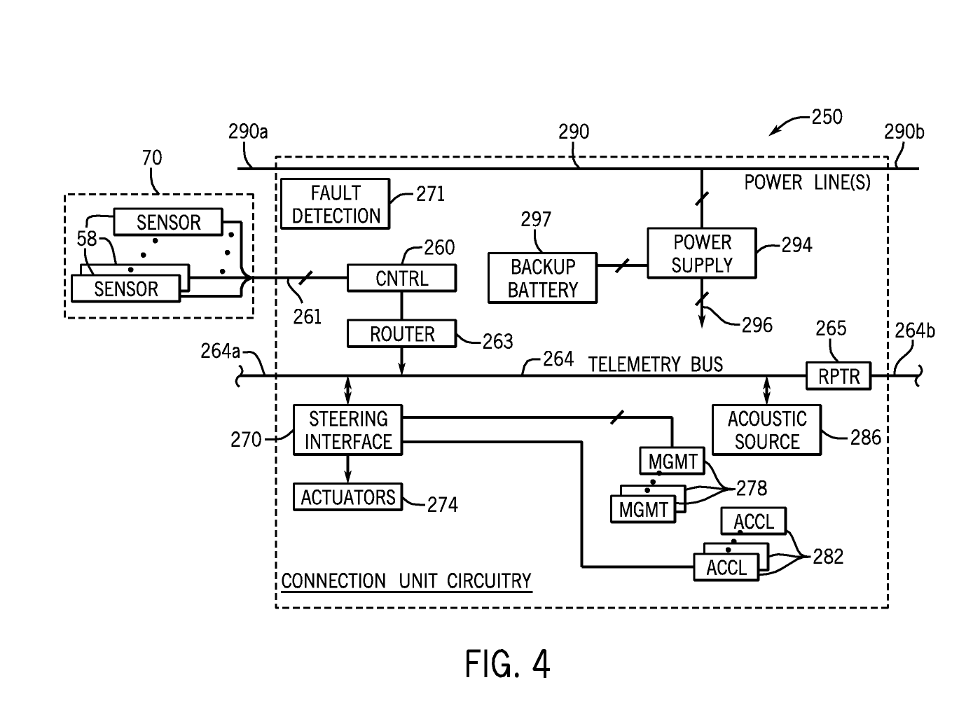

In accordance with embodiments of the invention, the connection unit circuit 250 may have an architecture that is depicted in FIG. 4. It is noted that FIG. 4 is merely an exemplary architecture, as many other architectures may be employed, as can be appreciated by the skilled artisan. For the example depicted in FIG. 4, the circuit 250 includes a controller 260, which gathers seismic data (i.e., pressure data and/or particle motion data) from an associated group 70 of the sensors 58. In this manner, in accordance with some embodiments of the invention, the sensors 58 may include seismic sensors (i.e., particle motion and/or pressure sensors), which are segregated into groups; and each group is associated with a different controller 260 (where each controller 260 is disposed in a different connection unit 100). The sensors 58 are not directly connected to the telemetry system of the streamer 30. However, this function is handled by the controller 260 and a router 263 that is disposed between the controller 260 and a telemetry bus 264 (described below). In this manner, the controller 260 is connected (via direct electrical wires 261, via optical fibers, via a subnetwork, etc.) to its associated group of sensors 58 to gather, or receive, the pressure/particle motion data from its group of sensors 58 and in conjunction with the router 263 introduce the gathered seismic data to the telemetry network the seismic streamer 30. It is noted that the sensors 58 may include sensors other than seismic sensors. For example, in some embodiments of the invention, the sensors 58 may include at least depth sensor, which provides data that is communicated to the streamer's telemetry network via the controller 260 and router 263.

In accordance with some embodiments of the invention, the controller 260 is a node on the telemetry bus 264, which extends through the streamer 30. Thus, each controller 260 serves as a bridge between the streamer's telemetry network and its associated group of sensors 58.

For the example depicted in FIG. 4, the telemetry bus 264 may be a single wire or multiple wire bus (a serial bus, for example). Inside the connection unit 100, these wires have corresponding termination ends 264a and 264b that are exposed at the connectors 232 and 234 (see FIG. 3) for connection to the corresponding telemetry bus wires in the adjacent streamer sections 70. In some implementations, the telemetry bus 264 may be an optical bus, which, inside the connection unit 100, has its signals re-amplified by a repeater 265 of the unit 100. As shown in FIG. 4, the repeater 265 is disposed between ends 264a and 264b for optically connecting the telemetry bus 264 to corresponding optical fibers in the adjacent streamer sections 70.

The circuitry 250 of the connection unit 100 also includes a steering controller, which is formed from a steering interface 270 and electromechanical actuators 274 for purposes of controlling the movement of the wings 200 (see FIG. 3). In accordance with some embodiments of the invention, the steering interface 270 may be coupled to the telemetry bus 264 for purposes of communicating with other controllers and circuitry associated with controlling the position of the streamer 30. In other embodiments of the invention, the telemetry bus 264 may be dedicated to the communication of the pressure and particle motion sensor data, and as such, the steering interface 270 may communicate with other circuitry using a separate bus. Thus, many variations are contemplated and are within the scope of the appended claims.

To aid in the steering control, in accordance with some embodiments of the invention, the circuitry 250 further includes sensors to indicate the orientation and position of the connection unit 100. In this regard, in accordance with some embodiments of the invention, the circuitry 250 includes a compass, which is formed from accelerometers 282 and magnetometers 278 that are connected to the steering interface 270 for purposes of indicating the orientation of the connection unit 100 to the steering interface 270. More specifically, the information provided by the magnetometers 278 and accelerometers 282 may be used for purposes of indicating the heading of the connection unit 100 and may also be used for a position determination. The local angle of the connection unit 100 with respect to the streamer angle may also be used to provide optimal steering using the wings 200.

Among its other features, in accordance with some embodiments of the invention, the circuitry 250 may further include an acoustic source 286 (i.e., a “pinger” acoustic source). The acoustic source 286 emits a signal, which may be received by the seismic sensors 58 for purposes of determining positioning of the connection unit 100 and the seismic sensors 58. The connection unit circuitry 250 may also include, as depicted in FIG. 4, one or more power lines 290 that extend through the unit 100 for purposes of providing power to the electrical power consuming components of the unit 100. In this regard, the unit 100 may include a power supply 294 that is coupled to the power line(s) 290 for purposes of providing various internal power supply lines 296 to power the unit's circuitry. The connection unit 100 may also include fault detection circuitry 271 for purposes of detecting an electrical fault in the streamer's electrical system (a ground fault, for example).

As shown in FIG. 4, inside the connection unit 100, the power line(s) 290 may have corresponding terminations 290a and 290b, which are exposed at the connectors 232 and 234 (see FIG. 3) for connecting the power line(s) 290 to corresponding power line(s) in the connected streamer sections 70. As also depicted in FIG. 4, in accordance with some implementations, the circuitry 250 may include a backup battery 297 that is connected to the power supply 294 to, as its name implies, provide backup power before power is established through the streamer 30 or in the event that the power connection to the streamer's power source is interrupted.

Other embodiments are contemplated and are within the scope of the appended claims. For example, although the connection units 100 are described herein as connecting streamer cable sections together, in another embodiment of the invention, a particular connection unit may connect to the end of a particular streamer cable section and not join that section to another streamer cable section. For example, the connection unit 100 may be disposed on the end of the streamer and link the streamer's telemetry network to a processing/recording circuitry that is onboard a vessel that tows the streamer.

While the present invention has been described with respect to a limited number of embodiments, those skilled in the art, having the benefit of this disclosure, will appreciate numerous modifications and variations therefrom. It is intended that the appended claims cover all such modifications and variations as fall within the true spirit and scope of this present invention.

What is claimed is:

1. An apparatus comprising:
a streamer cable section comprising an associated group of seismic sensors; and
a unit to connect to an end of the streamer cable section, the unit comprising:
a steering device controllable to position the streamer section;
a controller to gather seismic data provided by the associated group of seismic sensors and introduce the seismic data to a telemetry network of a streamer;
a network repeater to repeat a signal communicated along the telemetry network; and
a router between the controller and the telemetry network.

2. The apparatus of claim 1, wherein the unit joins the streamer cable section to another streamer cable section.

3. The apparatus of claim 1, further comprising:
other streamer cable sections; and
other units to concatenate the streamer cable sections together to form the streamer, at least one of the other units comprising:
another steering device controllable to position one of the streamer cable sections associated with said at least one unit;
another controller to gather additional seismic data provided by another group of seismic sensors and introduce said additional second seismic data to the telemetry network;
another network repeater to repeat a signal communicated along the telemetry network; and
another router between said another controller and the telemetry network

4. The apparatus of claim 1, wherein the unit comprises:
a first connector to mechanically connect the unit to the streamer cable section; and
a second connector to mechanically connect the unit to another streamer cable section.

5. The apparatus of claim 1, wherein the steering device is adapted to control wings of the steering device to regulate a depth and lateral positioning of the unit.

6. The apparatus of claim 1, wherein at least one of the units further comprises:
an acoustic source adapted to emit an acoustic positioning signal.

7. The apparatus of claim 1, further comprises a compass to indicate a heading for the steering device.

8. The apparatus of claim 7, wherein the compass comprises magnetometers and accelerometers.

9. The apparatus of claim 1, wherein the seismic sensors comprise pressure and particle motion sensors.

10. The apparatus of claim 1, wherein the unit further includes a depth sensor to indicate a depth of the streamer cable section.

11. The apparatus of claim 1, wherein the unit further includes an electrical fault detection system.

12. The apparatus of claim 1, wherein the unit further includes a power supply.

13. The apparatus of claim 1, wherein the unit further includes a housing separate from the streamer cable section to contain the steering device, controller, repeater and router.

14. The apparatus of claim 13, unit further comprises a connector to mechanically connect the housing to the streamer cable section.

15. A method comprising:
concatenating streamer sections together using connection units to form a seismic streamer; and
in at least one of the connection units, disposing a steering device controllable to position the streamer, a controller to gather seismic data provided by a group of seismic sensors associated with one of the streamer sections and introduce the seismic data to a telemetry network of the streamer, a network repeater to repeat a signal communicated along the telemetry network and a router between the controller and the telemetry network.

16. The method of claim 15, further comprising:
for each unit of said at least one unit, powering components of the unit with a power source of the unit.

17. The method of claim 15, further comprising:
disposing an acoustic source in each unit of said at least one unit.

18. The method of claim 15, further comprising:
disposing a compass in each unit of said at least one unit.

19. The method of claim 15, further comprising:
disposing a depth sensor in each unit of said at least one unit.

20. The method of claim 15, further comprising:
disposing a fault detection system in each unit of said at least one unit.

21. The method of claim 15, further comprising:
towing the streamer with a vessel.
